(19) United States
(12) Patent Application Publication
(10) Pub. No.: US 2017/0211795 A1
(43) Pub. Date: Jul. 27, 2017

(54) FLEXIBLE COILED ARTERY WICK

(71) Applicant: PHILIPS LIGHTING HOLDING B.V., EINDHOVEN (NL)

(72) Inventors: Simon Eme KADIJK, EINDHOVEN (NL); Vincent Stefan David GIELEN, EINDHOVEN (NL)

(73) Assignee: PHILIPS LIGHTING HOLDING B.V., EINDHOVEN (NL)

(21) Appl. No.: 15/328,354

(22) PCT Filed: Jul. 21, 2015
(86) PCT No.: PCT/EP2015/066685

§ 371 Date: Jan. 23, 2017

(30) Foreign Application Priority Data
Jul. 22, 2014 (EP) 14177953.8

(51) Int. Cl. F21V 29/51; F21V 29/58; F21V 23/06; F21K 9/237; F21K 9/235; F21K 9/232; F21V 3/02

(52) U.S. Cl. CPC F21V 29/51; F21K 9/232; F21V 29/58; F21V 3/02; F21K 9/237; F21K 9/235; F21V 23/06; F21Y 2115/10

(57) ABSTRACT

The invention provides a lamp (1) comprising a light source (10), and a light transmissive heat pipe (251) configured to dissipate thermal energy from the light source (10), wherein the heat pipe (251) has an internal surface (53) and includes a heat pipe working fluid (252), wherein the heat pipe (251) further includes a flexible conduit (270) configured as wick, wherein the flexible conduit (270) comprises a flexible conduit connection part (271a), an outer face (273), a longitudinal channel (274) with an opening at an end (271, 272), and at least one side opening (275) in the outer face (273) to the longitudinal channel (274), wherein the flexible conduit (270) is connected at the flexible conduit connection part (271a) with the internal surface (53) at a first position (51).

### FIELD OF THE INVENTION

The invention relates to a (solid state light source based) lamp and to a heat pipe for such lamp. The invention further relates to wick for such lamp or heat pipe. The invention even further relates to a luminaire comprising at least one such lamp.

### BACKGROUND OF THE INVENTION

The issue of heat management of LEDs in lamps is known in the art. US2013/0162139, for instance, describes a LED bulb including a top optical section, a middle heat dissipation section, and a bottom electrical section. The optical section includes a light source and a light guider. The light source further includes a substrate and at least one LED arranged on the substrate. The heat dissipation section includes a sleeve at a rear of the optical section and a chamber. The sleeve has a tube portion and a sealed end with a heat absorbing surface thermally contacting the substrate. A porous wick structure is arranged on the outer sidewall of the tube portion and contains working fluid therein. The chamber has an annular configuration defined between an inner side surface of an LED bulb shell and an outer side surface of the sleeve. The electrical section includes a threaded cap arranged at a bottom portion of the LED bulb, and a circuit board received in the sleeve.

WO2013/060357 describes a light emitting component, comprising at least one light emitting diode, a sealed housing enclosing the at least one light emitting diode, a cooling liquid inside the housing that is electrically isolating, colorless, transparent, and can be evaporated by means of a local temperature increase, and comprising at least one absorbent element for absorbing and/or conveying cooling liquid. The absorbent element is configured and/or arranged in the housing such that it brings the cooling liquid to the at least one light emitting diode.

US2011/0176316 describes a lamp for general lighting applications. The lamp utilizes solid state light emitting sources to produce and distribute white light and dissipate the heat generated by the solid state light emitting sources. The lamp includes a thermal handling system having a heat sink and a thermal core made of a thermally conductive material to dissipate the heat generated by the solid state light emitting sources to a point outside the lamp.

US2011/0074296 describes an LED illumination apparatus. The apparatus includes a body having a lower portion adapted for coupling to a power socket and an upper portion provided with a power source module accommodating chamber. A heat-dissipating module includes a funnel-shaped hollow case disposed at a top end of the upper portion and filled with a coolant fluid, wherein the hollow case has a small diameter open end adjacent to the body and a large diameter open end remote from the body. A light source module includes amounting substrate disposed at the small diameter open end, an LED mounted on the mounting substrate, and a power source module disposed within the power source module accommodating chamber in a manner electrically connected to and supplying working power to the LED.

### SUMMARY OF THE INVENTION

LED based solutions are less than 100% efficient. The heat that is generated during operation generally leads to temperatures in the application that may deteriorate the system efficacy and may limit the lifetime of the LEDs and/or other components. In order to transfer heat to the ambient, LED devices generally use a heat sink. In most LED applications the heat sink and the light emitting area are two separate elements. The size of the heat sink is in general smaller than the total lamp enclosure, limiting the heat transfer to the ambient and thus the thermal performance.

Another option, distributing the LEDs over a 3D curved outer enclosure, leads to complex and expensive solutions, while using flat surfaces leads to deviating shapes of the lamp or luminaire. Other LED based solutions may include LEDs placed inside a transparent or translucent container and a special gas like helium is used to enhance the internal heat transfer from the LED source(s) to the enclosure. The inside heat transfer from LED source towards this enclosure via convection or conduction through the gas is not very effective. Hence, also the above options that have been investigated suffer from a poor thermal performance.

The suggested systems thus seem to suffer from thermal management problems which may only be solved (partially) at the cost of optical properties. Vice versa, when optimizing optical properties, thermal management is a problem.

Hence, it is an aspect of the invention to provide an alternative lamp, which preferably further at least partly obviates one or more of above-described drawbacks.

Herein, it is suggested to use a heat pipe. Hence, it is also an aspect of the invention to provide an alternative heat pipe, and/or wick for such heat pipe, which preferably further at least partly obviate one or more of above-described drawbacks. Heat pipes and vapor chambers generally have a capillary structure to return the liquid phase to the evaporator, i.e. the place where the heat source is connected. The capillary structure is called the wick which should work together with the liquid phase of the working fluid to pump the liquid. The main properties of wick layers or structures are:
1. a low contact angle with the fluid (good wetting);
2. a high capillary pressure; and
3. a high permeability to fluid flow.

The capillary openings (pores) are a determining factor in the capillary pressure; the pores can be less than 1 μm to a few hundreds of μms in size, depending on the application. Wick structures that may be used are selected from a mesh, grooves and sintered powder.

In a vapor chamber or heat pipe a capillary wick structure can be applied on all internal container walls. However, in some cases this wick structure is less desired, e.g. in glass vapor chambers as applied in clear bulbs or clear candles, that should transmit light and should be transparent, e.g. transparent glass. Further, the application of such wick layers may be complicated. Also, the wick layer may degrade over time.

Herein, it is also suggested to use flexible coiled arteries as wicks. Tiny coiled arteries can be present on the inside walls of the glass container with only little effect on the transparency and look and feel of the glass part, and could even be decorative. Another option is to attach these coiled wicks to the evaporator, i.e. a hot or the hottest spot, and have one end or two ends hanging free in the gravitational field. If the coiled wick is sufficiently long these ends always reach the lowest part of the container where also the liquid collects.

Hence, in a first aspect the invention provides a lamp comprising a light source, configured to generate light source light (herein also indicated as “light” or “visible light”), and a light transmissive heat pipe (“heat pipe”) configured to dissipate thermal energy from the light source, wherein at least part of the heat pipe is transmissive for at least part of the light source light, and wherein the light source is especially configured to provide at least part of the light source light downstream from the heat pipe, wherein the heat pipe has an internal surface and includes a heat pipe working fluid (also indicated as “working fluid” or shortly “fluid”), wherein the heat pipe further includes a flexible conduit configured as wick, wherein the flexible conduit comprises a flexible conduit connection part, an outer face, a longitudinal channel with an opening at an end, and especially also at least one side opening (herein also indicated as “capillary pores”) in the outer face to the longitudinal channel, wherein the flexible conduit is connected at the flexible conduit connection part with the internal surface at a first position (especially the evaporator).

Such flexible conduit configured as wick, which is herein also indicated as “flexible wick” or “conduit” or “artery”, may have the advantages of a high permeability in combination with a high capillary force. Further, such conduit is flexible and may reach (in embodiments) the most remote ends. Due to the flexibility, in principle any configuration of the lamp may be allowed, as the end of the wick may reach (into) condensed heat pipe working fluid. Further, one may choose to use transparent material, such as glass, by which light absorption may be minimized (see also below).

As indicated above, the flexible conduit comprises a flexible conduit connection part, an outer face, a longitudinal channel with an opening at an end, and at least one side opening in the outer face to the longitudinal channel. In a specific embodiment, the longitudinal channel has an equivalent circular diameter selected from the range of 5-2000 μm, such as especially 10-1000 μm, like 20-500 μm. With smaller diameters, the flow resistance may be too high and with larger diameters the capillary forces may be too low. Herein, the term “equivalent circular diameter” is applied, as the conduit does not necessarily have a circular cross-section. In principle, the conduit may also have a square or rectangular or oval or other shaped cross-section. The equivalent circular diameter can be defined as 2*sqrt(Area/PI); i.e. the diameter of the circle that would have the equivalent area as the cross-section of the conduit.

In yet a further specific embodiment, the flexible conduit has a length which is large enough to be in physical contact with a part of the internal surface most remote from the first position. Optionally, the second end may be connected to the internal surface of the heat pipe, though this is not necessary. Further, the term “flexible conduit” may also refer to a plurality of flexible conduits. Characteristic lengths of the flexible wick may depend upon the type of lamp, and thus the geometry of the heat pipe used, but may e.g. be in the range of 5-1000 mm, such as 10-500 mm.

The flexible conduit is connected to the internal surface at the first position. In general, this position is chosen to be part of the heat pipe that becomes hottest (hot spot or hottest spot, also indicated as “evaporator”) during operation of the lamp. The flexible conduit may be connected to this position at a plurality of points, such as over part of its length. Especially, at least part of the flexible conduit is not connected to any part of the heat pipe (and may thus move when the heat pipe is moved). Even more especially, over at least 50% of its length, yet even more especially over at least 80% of its length, the flexible conduit may not be connected to any part of the heat pipe.

The flexible conduit will have a first end and a second end. In embodiments, the first end may be connected to the first position at the internal surface. However, in another embodiment, a position in between the first end and the second end may be connected to the first position. In such embodiment, at both sides of the first position the flexible conduit extends, with equal or unequal lengths. In fact, in such embodiment two conduits are provided, with two second ends. Hence, the herein indicated flexible conduit connection part may in principle be any part of the flexible wick, but may in general be the first end, the second end, or somewhere about in the half the length of the flexible wick. Likewise, the first position can be any position within the heat pipe, but will in general be the position that will become relatively hot, or become the hottest spot at the heat pipe during operation of the lamp. The term “hot spot” or “hottest spot” and similar terms may also refer to an area.

The flexible conduit can be connected in several ways to the internal surface of the heat pipe. Amongst others, the flexible conduit may be connected at the flexible conduit connection part with the internal surface at the first position via a sol-gel coating. Additionally or alternatively, the flexible conduit may be wound around an internal part of the heat pipe. For instance, the heat pipe may include an indentation in the wall (such as formed by the first cavity (see below)), around which the heat pipe may be wound. Alternatively or additionally, flexible conduit connection part of the flexible conduit may be soldered or melted to the first position of the internal surface, with the remainder of the flexible conduit not being or optionally being connected to another part of the internal surface.

In a specific embodiment, the lamp as described herein further comprises a (solid state) light source support in thermal contact with the heat pipe, such as especially with the first envelope, at the first position. This may facilitate transfer of thermal energy to the heat pipe, for dissipation thereby. In yet a further embodiment, the (solid state) light source support includes a heat sink, wherein the heat sink is in physical contact with heat pipe, such as especially with the first envelope, at the first position. Especially, at the position where the support or heat sink is in thermal, especially physical, contact with the heat pipe, this position (in fact at the other side of the wall of the heat pipe) may be indicated as evaporator.

In yet a further embodiment, the flexible conduit is provided by a helical structure, wherein the side opening is a helically shaped side opening provided by said helical structure, wherein the helical structure has a diameter selected from the range of 2-1000 μm, such as especially 5-500 μm, like 10-250 μm. Optionally, the flexible conduit may be provided by two or more helical structures, such as a double helix structure or a triple helix structure. The diameter indicated here is not the channel diameter of the longitudinal channel, but the diameter of the winding forming the helical structure(s). In general, the diameter of the winding is smaller than the channel diameter. Hence, in specific embodiment, the flexible conduit may be a helical spring or have the shape of a helical spring. Here, the flexibility in a longitudinal direction is of less relevance. Especially, flexibility perpendicular to a longitudinal axis is of more relevance, especially to allow the flexible coil reach a furthest part of the heat pipe.

These types of helical structures are similar to a spring, with especially non-zero distances between the windings. In fact, these distances in such (helical) embodiments are a single elongated opening, also having a helical shape. The distance between these windings are as indicated below, and may facilitate permeability of the liquid, to be drawn in the longitudinal channel. Another feature of such helical structures is that these may be relative open, which may be desired in view of absorption losses.

The flexible conduit may include one or more side openings. These opening(s) may include a helically shaped side opening or helical (side) opening (see above) and/or may include other type of opening(s). At least, such side opening has a smallest dimension selected from the range of 0.1-500 μm. Hence, e.g. circular side openings may be applied with a diameter in the range of 0.1-500 μm, such as especially 1 μm. However, in the above described helical structure, the distance between two windings may be in this range, and may even be below 10 μm, such as below 2 μm. The total length, however, may be much longer in the embodiment of a helical structure. Hence, in another embodiment the flexible conduit comprises a plurality of side openings. For instance, the flexible wick may be tube like structure with a plurality of (small) openings. Note that in the case of flexible conduits of the helical type, when the flexible conduit is bent (such as may be the case during operation), some openings may be closed, and some may be (more open). Here, the shortest distances especially refer to a situation when the flexible coil is not subjected to any force, except gravitational force. Further, one or more of the first end and the second end(s) may be open, but one or more of these may also optionally be closed as transport of working fluid may also happen through the side opening(s).

The flexible conduit may be made of different types of materials, e.g. metal, glass, ceramic, polymer, etc. In principle, (also) the same materials as described below with respect to the heat pipe may be applied. When the wall of the flexible conduit is relative thin, flexibility may be provided. Especially in the case of the helical flexible wicks, even materials that are inflexible when provided in thick layers or pieces, may be flexible (when provided in thin layers or thin helical structures). Hence, the wall thickness or diameter (in the case of windings of a helical structure) is, as indicated above, especially in the range of 2-1000 μm, such as especially 5-500 μm, like 10-250 μm. In the case of metals or glass or quartz or ceramics, the thickness may especially be in the range of about 2-20 μm.

In a specific embodiment, the flexible conduit comprises a light transmissive material such as quart of glass, or optionally a polymer as indicated above for the heat pipe. In yet a further embodiment, the flexible conduit comprises a (woven or non-woven) fibrous material, such as especially glass fiber, such as a glass fiber sleeve, in which the fibers, such as especially the glass fibers, have the typical diameters selected from the range of 1-6 μm, especially of 5-30 μm, such as especially around 10-15 μm, such as about 13 μm. As the fibers can move with respect to each other, the bending stiffness is low.

The flexibility may e.g. be indicated by the curvature that can be created. For instance, the curvature that can be created with the flexible wick may be a radius of smaller than 10 cm, or even a radius smaller than 5 cm, such as a radius in the range of 0.2-20 mm. Good flexibility may e.g. obtained when the radius of the curvature is equal to or larger than twice the (external) conduit diameter.

In yet a further aspect, the invention also provides the heat pipe per se, i.e. a light transmissive heat pipe configured to dissipate thermal energy from a light source, wherein at least part of the heat pipe is transmissive for visible light, wherein the heat pipe has an internal surface and includes a heat pipe working fluid, wherein the heat pipe further includes a flexible conduit configured as wick, wherein the flexible conduit comprises a flexible conduit connection part, an outer face, a longitudinal channel with an opening at an end, and optionally at least one side opening in the outer face to the longitudinal channel, wherein the flexible conduit is optionally connected at the flexible conduit connection part with the internal surface at a first position. This first position may especially be selected based on the expected future application in a lamp.

In another aspect, the invention also provides the flexible conduit per se, i.e. a flexible conduit configurable as wick, an outer face, a longitudinal channel with an opening at an end, and optionally at least one side opening in the outer face to the longitudinal channel, wherein the longitudinal channel has an (equivalent circular) diameter selected from the range of 10-1000 μm, wherein the flexible conduit is provided by a helical structure and wherein the side opening is a helically shaped side opening provided by said helical structure, wherein the helical structure has a diameter selected from the range of 5-500 μm, and wherein the side opening has a smallest dimension selected from the range of 0.1-500 μm. Such flexible conduit may be connected to the internal surface of a heat pipe (or a heat pipe to be). The part of the flexible wick connected to said internal surface is indicated as flexible conduit connection part. In general, this flexible conduit connection part is only part of the outer face or wall of the flexible conduit.

In another aspect, the invention also provides a luminaire comprising at least one lamp according to the invention.

The heat pipe is a (closed) container or enclosure comprising the working fluid and the flexible conduit. At least part of the heat pipe is transmissive for light of the light source. In embodiments, the heat pipe may be shaped in such a way that there is a cavity, wherein the light source, especially a solid state light source, may be configured. In yet an even more specific embodiment, such heat pipe may be provided by assembling a first envelope and a second envelope together, thereby forming such enclosure or container, i.e. the heat pipe.

Hence, in a specific embodiment, the lamp comprises:

a (solid state) light source and a first envelope at least partially enclosing the (solid state) light source, thereby forming a first cavity hosting said (solid state) light source, wherein at least part of the first envelope is transmissive for visible light generated by the (solid state) light source;

a second envelope at least partially enclosing the first envelope, wherein the first envelope and the second envelope provide a second cavity at least partially enclosing the (solid state) light source, wherein at least part of the second envelope is transmissive for visible light generated by the (solid state) light source and transmitted through the first envelope into the second cavity, wherein the second cavity is configured as said heat pipe comprising said heat pipe working fluid.

In an embodiment, the first envelope at least partially encloses the light source. In general, the first envelope will include a cylindrical part, having a diameter which is constant over at least part of the length of the first envelope, and having an opening at one side. The power assembly may at least partly be arranged into the first envelope. The entire first envelope may have a uniform diameter. Optionally, the diameter of the first envelope may vary over its length.

The light source especially comprises a light emitting surface, relative to the light emitting surface, the first envelope may enclose the light source over an angle larger than 180°, such as e.g. 270° or larger. Hence, a distance from the light source to the first opening at a first end (“one side”) of the first envelope may be larger than a distance between the light source and a second end (“opposite side”) of the first envelope, wherein the first end and the second end substantially define the length of the first envelope. Such configuration improves distribution of the light and distribution of heat. Hence, in this way the lamp may be more efficient.

The present invention allows a transfer of heat to substantially the full outer surface of the enclosure or heat pipe (such as the external surface of the second envelope), which offers the maximum possible thermal performance. Further, the invention allows the integration of the optical, mechanical and thermal function in the enclosure (or envelope). Herein, the tern enclosure especially refers to the heat pipe, which encloses the volume containing the working fluid and flexible conduit. The invention allows embodiments with e.g. fully glass or ceramics based vapor chamber (i.e. heat pipe), transparent or translucent, with no other components in it except for the flexible wick and the working fluid to enable a reliable long time operation. The (solid state) light sources are not subjected to undesired gas conditions (within the second cavity or heat pipe), and the heat pipe provides an efficient heat management. Hence, herein the light source is thus especially configured external from the light transmissive heat pipe. With a (small but) sufficient amount of the working fluid that in liquid condition can be contained in the wick, the wick allows the liquid to be transported back towards the heat source (such as the outer surface of the first envelope in above described embodiment). Especially, all orientations of the lamp are effective for cooling, as the wick is flexible, and will always due to gravity be directed to the lowest point.

The outer surface of the heat pipe or enclosure is herein also indicated as the external surface (of the heat pipe). Heat from the light source dissipates to this outer surface via the heat pipe principle. Working fluid in the heat pipe closest to the heat source, i.e. the light source and/or a heat sink will evaporate, and will condense further away and migrate due to gravity to the lowest part of the heat pipe. Here, the flexible wick may—by capillary—forces transport the liquid in the direction of the heat source, where the cycle may start again. Therefore, the flexible wick is also indicated as “artery”. The advantage of the side opening(s) is that not only via the second end but also via the side opening liquid may enter the longitudinal channel.

In this invention, substantially the full outer enclosure may be used for heat transfer to the ambient, since the full enclosure may be at a substantially uniform (high) temperature dictated by the internal vapor chamber temperature (see below). At the same time the vapor chamber may have an optical function and is forming the mechanical enclosure of LEDs and electronics.

The vapor chamber is a hermetically sealed chamber especially containing a single pure fluid and vapor chamber compatible materials only. This ensures the substantial isothermal condition in the vapor chamber and the maximum thermal performance. It may be manufactured as a separate part, allowing the full use of glass or ceramics processing like heating in an oven (e.g. to 400° C.) to remove (organic) contamination, vacuum pumping, and filling with a pure fluid and subsequent hermetic sealing by glass processing. All common fluids that are used for operation around room temperature, like water, methanol, ethanol, acetone or ammonia are compatible with e.g. a glass or ceramic container. Similarly the wick materials (see below) can be chosen to be compatible with the working fluid.

A heat pipe or heat pin is a heat-transfer device that combines the principles of both thermal conductivity and phase transition to efficiently manage the transfer of heat between two solid interfaces. At the hot interface of a heat pipe a liquid in contact with a thermally conductive solid surface turns into a vapor by absorbing heat from that surface. The vapor then travels along the heat pipe to the cold interface and condenses back into a liquid—releasing the latent heat. The liquid then returns to the hot interface through capillary action, centrifugal force, or gravity, and the cycle repeats. Due to the very high heat transfer coefficients for boiling and condensation, heat pipes are highly efficient thermal conductors. For the heat pipe to transfer heat, it especially contains a liquid and its vapor at saturated vapor pressure (gas phase) (at least at operation conditions). The liquid vaporizes and travels to a condenser spot (the internal surface of the second envelope), where it is cooled and turned back to a liquid. In a standard heat pipe, the condensed liquid is returned to the evaporator (external surface of the first envelope) using a wick structure exerting a capillary action on the liquid phase of the working fluid. The full strength of two-phase cooling solutions is used in the generally known concepts of the heat pipe and the vapor chamber. In such structures there is essentially a single fluid contained in a hermetically sealed container. Usually a second element is a porous capillary structure (the wick) to lead the liquid phase back to the heat source location. Cleanliness, purity and compatibility of all materials inside the heat pipe or vapor chamber are relevant, as known to the person skilled in the art, in order to prevent gasses to develop that quickly deteriorate the performance. Such heat pipes and vapor chambers are especially configured to operate at the saturation pressure of the fluid and have an (almost) uniform temperature inside the container as condensation or evaporation takes place whenever the temperature deviates from the internal temperature.

Optionally, the heat pipe comprises over at least part of its internal surface also a wick layer or wick (i.e. in addition to the flexible wick).

Especially, the heat pipe working fluid comprises one or more of H₂O, methanol, ethanol, i-propanol, 1-propanol (iso propanol), butanol (such as 1-butanol), acetone, and (optionally) ammonia, etc. Especially, the working fluid comprises a fluid that has a boiling point selected from the range of −50-150° C. (at atmospheric pressure). Especially, the working fluid comprises a fluid that has a boiling point at atmospheric pressure above the expected working temperature range of the heat pipe, especially boiling point in the range of 60-130° C. Further, during operation of the lamp, fluid will condense at the internal surface of the second envelope, and be transported to the hot spots at the first envelope, close to the light source, and then vaporize again, followed by transport of the fluid as gas to the second envelope again, etc. In an embodiment, the working fluid is selected of one or more of ammonia, pentane, acetone, methanol, ethanol, propanol, heptane and water, especially one or more of water, ethanol and methanol, even more especially one or more of water and ethanol. In yet a further embodiment, the working fluid comprises one or more of H₂O, methanol, ethanol, propanol (such as one or more of 1-propanol and i-propanol), butanol (such as one or more of 1-butanol, 2-butanol, etc.), acetone, pentane, heptane, and (optionally) ammonia.

The working fluid may comprise a substantially pure fluid, such as less than 10 vol. %, especially less than 5 vol. %, even more especially less than 1 vol. % of the total fluid being other fluids (such as a non-condensable fluid; see below) than the main fluid. For instance, one may include (liquid) water in the heat pipe and remove air by evacuation, which may provide the substantially pure working fluid, such as pure water. However, optionally one may (deliberately) include a non-condensable fluid, such as air, and/or or especially a low density gas like He or Ne. By choosing the fluid and/or by tuning the fluid composition an acceptable internal pressure close to the atmospheric pressure may be obtained at the operating temperature of the heat pipe, and also a minimum internal pressure at room temperature, i.e. when the lamp is in off-state. In an embodiment, a non-condensable gas may be available having a partial pressure (of the non-condensable gas) at room temperature selected from the range of 0-100 kPa, like, below 50 kPa. The total pressure of the fluid in the heat pipe at room temperature may be 1 bar (atmospheric pressure) or even higher, but is especially lower, such as 0.5 bar or lower, such as in the range of 0.1-0.5 bar. Especially when using ceramic envelopes, a pressure larger than 1 bar at room temperature may be possible.

A derivative solution is to deliberately add a controlled amount non-condensable gas to the vapor chamber in order to guarantee a minimum internal pressure in the container and thereby reduce the stresses on the vapor chamber container that arise from the difference between ambient en internal pressure. In this way, a balance can be between thermal performance and mechanical robustness of the system. Preferably, the container is shaped in such a way that the non-condensable gasses are not trapped in a section of the container but can mix with the evaporating fluid.

The heat pipe is especially configured to transport the heat from the light source to the (remainder of the) outer surface of the heat pipe second envelop. Hereby,—in some embodiments—the heat has to be transferred through the first envelope. Hence, especially, the light source may be in thermal contact with the first envelope (or the outer surface of the heat pipe). This may by physical contact and/or a heat transfer element. In yet another embodiment, the lamp may comprise a solid state light source support in thermal contact with the first envelope (or the outer surface of the heat pipe). This support may include a PCB (printed circuit board). The support may be in physical contact with the first envelope (or the outer surface of the heat pipe). In a specific embodiment, the solid state light source support includes a heat sink, and wherein the heat sink is in thermal contact with the first envelope, especially in physical contact with the first envelope (or the outer surface of the heat pipe). Especially, the solid state light source support includes a heat sink, wherein the heat sink comprises a ceramic heat pipe. In such embodiment, the lamp includes two heat pipes. As indicated above, optionally also a thermally conductive paste to improve thermal contact between the support and the first envelope.

Especially, the invention provides the use of a hermetically sealed transparent or translucent container as a vapor chamber in which especially no foreign elements are introduced and which can be manufactured as a separate part using e.g. high temperature glass or ceramics processing, which allows assembling in the lamp under normal ambient temperature conditions. The LEDs and the electronics are placed at the outside of the container (such as the second cavity), as no foreign elements, except for the wick and working fluid (see below), are desired in the heat pipe.

In embodiments, the same glass or ceramics (or other material) container is an optical element of the LED lamp or luminaire to distribute the light all around, or directional, and the same glass or ceramics (or other material) container is a mechanical enclosure of LEDs and driver.

Especially, the material of the heat pipe, such as the first envelope and/or the material of the second envelope, may comprise one or more materials selected from the group consisting of a transmissive organic material support, such as selected from the group consisting of PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), silicone, polyvinylchloride (PVC), polyethylene terephthalate (PET), (PETG) (glycol modified polyethylene terephthalate), PDMS (polydimethylsiloxane), and COC (cyclo olefin copolymer). However, in another embodiment the material of the heat pipe, such as the first envelope and/or the material of the second envelope, may comprise an inorganic material. Preferred inorganic materials are selected from the group consisting of glasses, (fused) quartz, transmissive ceramic materials, and silicones. Also hybrid materials, comprising both inorganic and organic parts may be applied. Especially preferred are PMMA, transparent PC, or glass as material for the material of the first envelope and/or the material of the second envelope. Hence, the heat pipe, or one or more of the first envelope and the second envelope comprise a material independently selected from the group consisting of glass, a translucent ceramic, and a light transmissive polymer. Especially, the first envelope and the second envelope comprise the same material.

Especially, the material of the heat pipe, such as the first envelope and/or the material of the second envelope have a light transmission in the range of 50-100%, especially in the range of 70-100%, for light generated by the lighting source and having a wavelength selected from the visible wavelength range. In this way, the first envelope and/or the second envelope are transmissive for visible light from the light source. Herein, the term “visible light” especially relates to light having a wavelength selected from the range of 380-780 nm. The transmission or light permeability can be determined by providing light at a specific wavelength with a first intensity to the material and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

Especially, the entire heat pipe (wall) is transmissive for visible light.

As indicated above, the above mentioned materials for the heat pipe may also be applied as flexible conduit (artery) material.

The present invention thus especially provides a thermo-optical enclosure for LED lighting applications. Further, the present lamp can be made in various embodiments, such as with a “GLS (general lighting service) look and feel”. As all three functions, (i) thermal management, (ii) light distribution and (iii) optionally mechanical/safety enclosure are taken up by the thermo-optical enclosure (i.e. the envelope assembly), a minimal use of metals and polymers is possible.

The term “solid state light source” is herein also indicated as “light source”. The term “light source” may also relate to a plurality of light sources, such as 2-20 solid state light sources, though in specific embodiments much more light sources may be applied, such as 10-1000. Hence, the term LED may also refer to a plurality of LEDs. The light source may comprise a solid state LED light source, such as a LED or laser diode. Solid-state lighting (SSL) refers to a type of lighting that uses semiconductor light-emitting diodes (LEDs), organic light-emitting diodes (OLED), or polymer light-emitting diodes (PLED) as sources of illumination. When more than one light source is applied, optionally these may be controlled independently, or subsets of light source may be controlled independently. The light source is configured to generate visible light, either directly or in combination with a light converter especially integrated in the solid state light source, such as in a dome on a LED die or in a luminescent layer (such as a foil) on or close to a LED die.

In yet another embodiment, the lamp includes at least two subsets of solid state light sources, for instance arranged within the first cavity. Optionally, the two or more subsets may be controlled individually (with a (remote) controller).

In an embodiment, the light source is arranged on a support. This support may be comprised by a power assembly. In an embodiment, also the light source is comprised by the power assembly (see further below). This support is at least partly arranged in the first cavity formed by the first envelope. The first envelope at least partially surrounds the light source. The support may include a material that has a good thermal conductivity. For instance, the support may include a metal layer or ceramic layer. Especially, the support is in physical contact with part of the internal surface of the first envelope. In this way, heat from the solid state light source may be transferred via the support to the first envelope. Then, via the heat pipe the thermal energy is dissipated at the external surface of the second envelope. Optionally, a thermal interface material, especially a thermally conductive paste, may be used to enhance the heat transfer from support to the first envelope. Especially, such thermal interface material may have a thermal conductivity of at least 0.5 W/(m·K), such as at least 1.0 W/(m·K), like at least 2.0 W/(m·K).

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”. Hence, especially the heat pipe is configured downstream of the light source. As at least part of the heat pipe may be transmissive for light, part of the light source light may be provided downstream from the heat pipe. Hence, especially the heat pipe is configured in a transmissive configuration, with at least part of the light source light penetrating into the heat pipe and at least part of the penetrated light source light also again escaping from the heat pipe. Hence, especially in this way the light source is configured to provide at least part of the light source light downstream from the heat pipe. Hence, the light source is configured external from the heat pipe. The heat pipe is especially substantially hollow, and substantially only filled with the working fluid (and further contains the flexible conduit).

The lamp and/or luminaire may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, green house lighting systems, horticulture lighting, or LCD backlighting.

Especially, fields of application are: Consumer Lamps: Candles, bulbs, spot lights, TLED; Professional lamps (especially street light lamps); Consumer Luminaires (Indoor); Professional Luminaires (Indoor spots, outdoor luminaries); Street lights: integrated Lamp-Luminaire designs; Special lighting: extreme environments (e.g. pigsties with ammonia levels), or underwater lighting (glass is watertight and can be easily coated to prevent organic growth); etc.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-1E schematically depict some aspects of the lamp;

FIGS. 2A-2D schematically depict some possible embodiments of the lamp;

FIGS. 3A-3B schematically depict some variants of the lamp.

FIG. 4 schematically depicts an embodiment of a luminaire.

The drawings are not necessarily on scale.

### DETAILED DESCRIPTION OF THE EMBODIMENTS

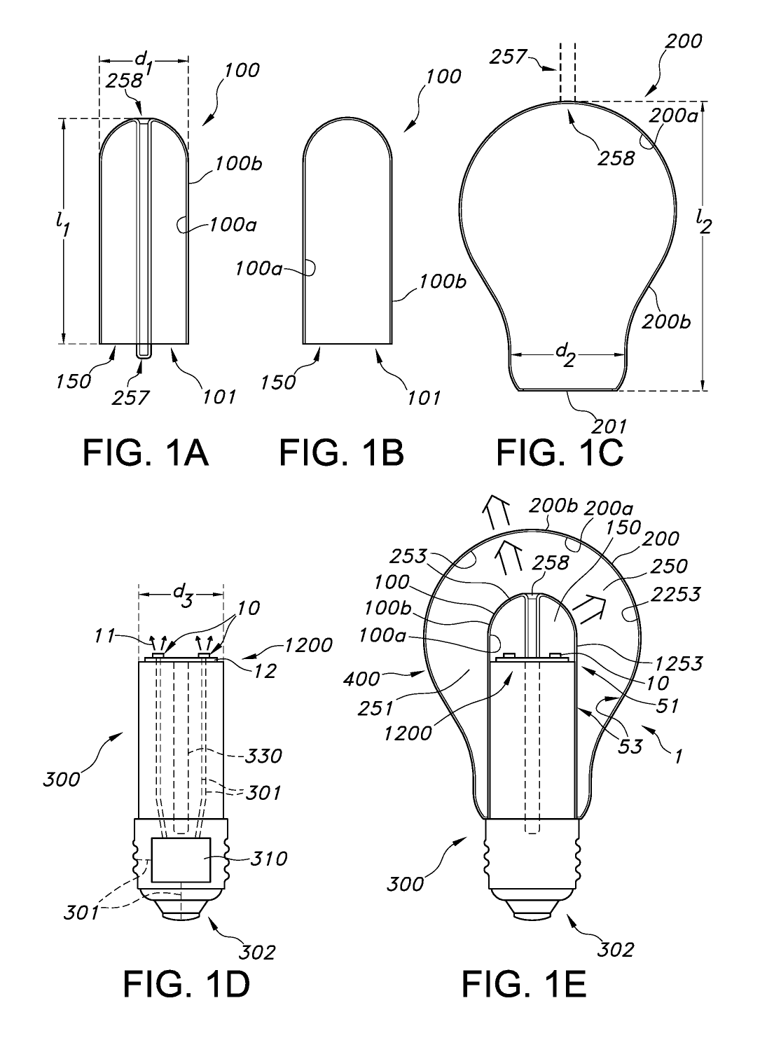

FIG. 1A-1E schematically depict several elements and options for assembling an embodiment of the lamp as defined herein. However, the invention is not limited to these types of lamps. FIG. 1A schematically depicts a first envelope 100, having a cavity 150, and a larger envelope (or cavity) opening 101 (at one side), and an optional smaller opening, herein also indicated as second cavity opening 258 (at another side). In this embodiment, the pump stem, indicated with reference 257, is associated with this second cavity opening. Though this second cavity opening 258 is an opening in the first envelope, it gives access to the second cavity (see below). The first envelope has an internal surface or upstream surface 100a, and an external surface or downstream surface 100b. In general, the first envelope 100 will include a part that is cylindrical, having a diameter d₁. The length of the first envelope is indicated with reference l₁. FIG. 1B schematically shows an embodiment of the first envelope 100 without the second cavity opening 258 (and pump stem 257).

The schematic drawing 1C shows an embodiment of the second envelope 200. The second envelope has an internal surface or upstream surface 200a, and an external surface or downstream surface 200b. Often, also the second envelope 100 may include a cylindrical part having a diameter d₂. This cylindrical part may enclose the cylindrical part of the first envelope 100 (see below). The second envelope 200 includes an opening 201, through which part of the first envelope 100 may be arranged. The length of the second envelop is indicated with reference l₂. Note that by way of example the second envelope includes optionally a second cavity opening 258 with pump stem 257.

FIG. 1D schematically depicts an embodiment of a power assembly 300. Here, the power assembly includes at least two light sources 10, configured on a support 1200, which also includes a heat sink 12. The light source 10 is configured to provide light 11, especially having a visible component. With dashed lines, electrical connections 301 are indicated, which are in electrical contact with an end cap 302, for instance an Edison cap. Reference 310 indicated by way of example electronics and/or a control unit, and may e.g. include a transformer and/or remote control elements. Reference 330 indicates a cavity for the pump stem remains. Note that the first envelope encloses the light source(s) 10 over angles of at least about 270°. The distance from the light source(s) 10 to the second end is substantially smaller than the distance to the first end, such as a distance ratio of the distance to the first end (with the opening 101) to the second end (well within the second envelope 200) of at least 1; here in this schematic embodiment (but also applicable to other embodiments, in the range of at least about 4.

For instance, one may combine the embodiments of FIGS. 1A and 1C (but especially without second cavity opening 258 and pump stem 257 of the embodiment of FIG. 1C), and power assembly 300 from FIG. 1D into the lamp 1 as schematically depicted in FIG. 1E. First the envelope assembly, indicated with reference 400 may assembled, then the desired working fluid 252 may be added and the right pressure conditions may be created, the pump stem may be closed, and then the power assembly 300 may be connected to the envelope assembly 400 (see also below). The heat pipe 251, i.e. the cavity 250 created by assembling the first envelope 100 and the second envelope 200 into the envelope assembly 400, has an internal surface 253, which includes at least part of the external surface 100b of the first envelope 100 and at least part (here substantially the entire) internal surface 200a of the second envelope 200. A (first) part of the first envelope is indicated with reference 1253 and a (second) part of the second envelope is indicated with reference 2253. The flexible wick (see below) may be attached e.g. to the first envelope 100 before assembling the assembly. Reference 51 indicates part of the lamp at the heat pipe 251 that may become hot during operation (sometimes also indicated as evaporator). This part is indicated as first position, and it is relevant that the flexible wick (see below), is connected to such part, for liquid transport to such hot spot or first position 51. Note that there may be more first positions. Further, the term first position may also refer to an area. The entire internal surface of the heat pipe 251 is indicated with reference 53.

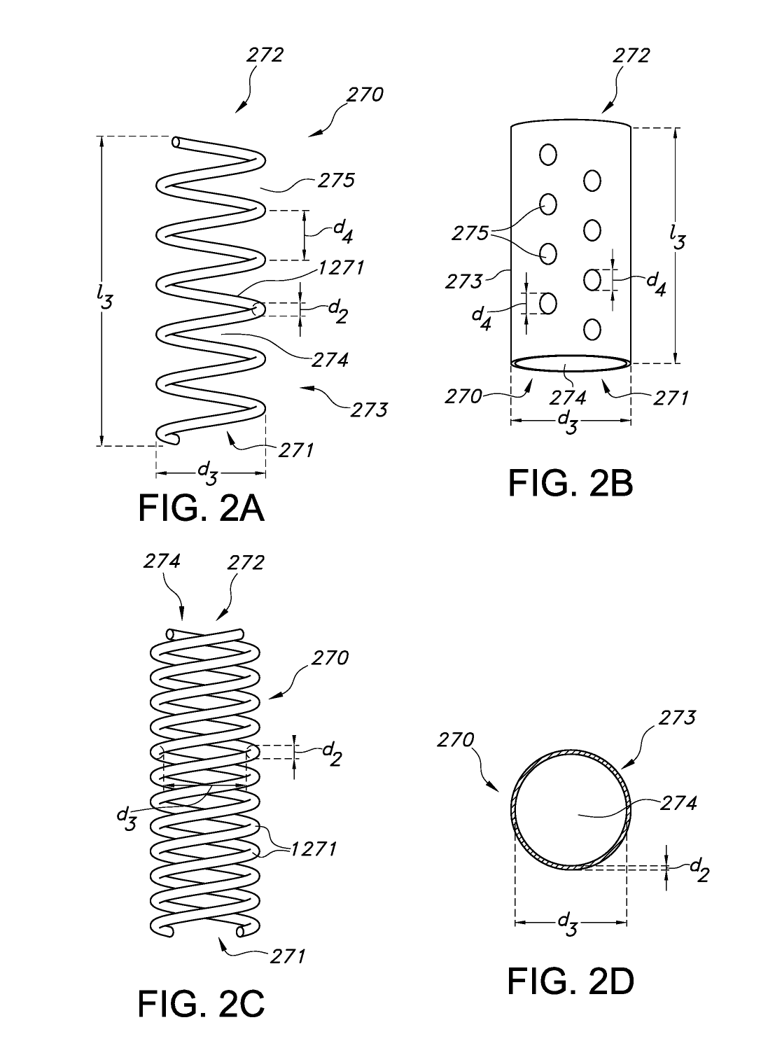

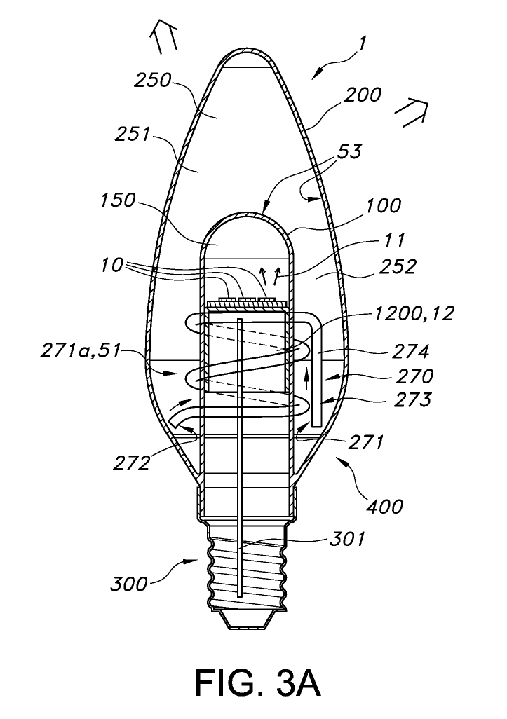

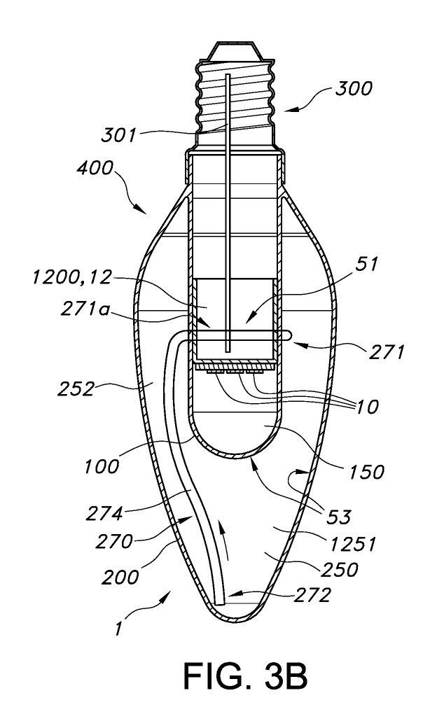

FIGS. 2a and 2b schematically depict two different embodiments of a flexible conduit 270. The flexible conduit 270 comprises an outer face or wall 273, a longitudinal channel 274 with an opening at an end 271,272, and at least one side opening 275 in the outer face 273 to the longitudinal channel 274. The flexible conduit 270 can be connected with any part, indicates as flexible conduit connection part 271a, with the internal surface 53 at a hot spot or first position 51. Flexibility of the conduit is especially of interest in a direction perpendicular to a longitudinal axis of the longitudinal channel 274 (see e.g. FIGS. 3a-3b).

FIG. 2a schematically depicts the flexible conduit 270 being provided by a helical structure 1271. Thereby, the side opening 275 is a helically shaped side opening provided by said helical structure 1271. The helical structure 1271 has a diameter d2 (i.e. the diameter of a winding), e.g. selected from the range of 5-500 μm. Note that in principle the diameter d2 may also be an equivalent circular diameter as the helical structure may not necessarily be based on an element with a circular cross-section; the windings may optionally have another type of cross-section. The longitudinal channel may have a diameter d3, which may e.g. in the range of 10-1000 μm. This diameter especially refer to the internal diameter. The distances between adjacent elements of the helix is indicated by reference d4. This is indicated also as smallest dimension, which may e.g. be in the range of 0.1-500 μm. Optionally, there may be a distribution of smallest dimensions. The longitudinal channel 274 may has a length L4. FIG. 2b shows a tube like flexible wick 270 with small circular or oval openings as side openings 275. Other shapes of side openings are possible as well. The smallest dimension d4 may e.g. be in the range of 0.1-500 μm (see also above). Optionally, there may be a distribution of smallest dimensions. FIG. 2c schematically shows an embodiment similar to the embodiment schematically depicted in FIG. 2a, but now with two helixes 1271, i.e. a double helix structure. A top view of these embodiments is shown in FIG. 2d. Diameter d3 is the internal (equivalent circular) diameter of longitudinal channel 274. The flexible conduit connection part is not indicated in these schematic drawings, as in principle each part can be used to connect to a heat pipe (see e.g. FIGS. 3a-3b. In FIGS. 2a and 2c, the outer face is especially defined by the windings/helical structure. In this outer face, there is a side opening 275, also defined by the helical structure(s). In FIG. 2b, the outer face is the wall of the tubular structure or tube.

FIG. 3a schematically depict a possible embodiment of the lamp 1 depicting a retro shaped candle lamp 1. At one (or more) positions light sources 10 may be arranged, for instance a light source array with an array of light sources 10. The light sources may be arranged closed to the internal face 100a of the first envelope 100, and especially in thermal contact therewith. Hence, FIG. 3a schematically depicts an embodiment of the lamp 1 comprising a light source 10, configured to generate light source light 11, and a light transmissive heat pipe 251 configured to dissipate thermal energy from the light source 10, wherein at least part of the heat pipe 251 is transmissive for at least part of the light source light 11 and wherein the light source 10 is configured to provide at least part of the light source light 11 downstream from the heat pipe 251. The heat pipe 251 has an internal surface 53 and includes a heat pipe working fluid 252, wherein the heat pipe 251 further includes a flexible conduit 270 configured as wick. The flexible conduit 270 comprises a flexible conduit connection part 271a, an outer face 273, a longitudinal channel 274 with an opening at an end 271,272, and at least one side opening (not depicted) in the outer face 273 to the longitudinal channel 274, wherein the flexible conduit 270 is connected at the flexible conduit connection part 271a with the internal surface 53 at a first position 51. This may be the part of the heat pipe that becomes hot(test) during operation of the light source(s) 10. Hence, this part may also be indicated as heat pipe. The length of the flexible wick 270 is depicted very schematically. They may be longer to reach positions most remote from the first position 51, such as the top of the lamp (see FIG. 3b) or the lowest position of the heat pipe (in this configuration of the lamp 1, the part of the heat pipe closest to the end cap (in this embodiment).

FIG. 3b schematically shows that in upside down configuration the flexible wick 270 may, due to gravity, seek the lowest point, where in general also the liquid will gather. Due to capillary forces, working fluid will be sucked in the direction of the first position. The migration direction is indicated with the arrow. Here, for the sake of clarity, the flexible conduit or wick has been depicted with a length to reach the most remote part (also in upside down position; or in any position). Note that the flexible conduits or wicks 270 are for the sake of simplicity sketched as closed tubes. However, they may also be helical based flexible conduits, such as schematically depicted in FIGS. 2a and 2c. FIG. 3a schematically depicts a flexible conduit with two loose ends, whereas FIG. 3b schematically depicts a flexible conduit with one loose end. In the former embodiment, the connection part 271a may e.g. be in the middle of the conduit, whereas in the latter embodiment it may be at the first end 271. Further, as will be clear to a person skilled in the art, also a plurality of flexible conduits may be applied. In such embodiment it is not necessary that all flexible conduits are arranged at the first position, though in an embodiment, they are all connected at the first position.

As shown in FIGS. 3a-3b, over parts of its length (13) the flexible conduit 270 is not connected to any part of the heat pipe. In FIG. 3b, the flexible conduit 270 is over at least 50% of its length not connected to any part of the heat pipe.

Hence, the invention provides a flexible wick for a heat pipe or vapor chamber consisting of a small diameter coil with multiple turns to form a capillary artery with semi-open walls for fluid pick up through the windings and axial fluid transport through the artery. The coiling allows brittle materials like glass fiber to be used, thereby maintaining the flexibility to shape the artery in a 3D structure and also allowing an artery wick that is bended by gravity to the bottom side of the heat pipe or vapor chamber.

Arteries with a considerable diameter compared to the mentioned capillary pores can be used next to the porous structures. These artery channels have much less pressure drop compared to a porous medium with fine pores and much more liquid flow per cross sectional area can be obtained. The arteries are connected to the space where the gas-phase is present via a narrow restriction or porous interface, to ensure that the high capillary pressure of the restriction or porous interface is pumping the liquid through the artery.

A possible artery is a tube with a porous wall, (optionally) closed at the ends. In special cases the artery could be open at one end where the liquid enters (at the condenser side), while at the point where the liquid leaves the artery (at the evaporator) the pore size is small to develop the capillary pressure. Such a structure could be a tube with walls of sintered powder.

This invention describes amongst others the use a flexible coil as a capillary artery. The wire or wires that build the coil can be made of suitable materials like (silica) glass fiber, ceramic fiber, metal wire, plastic fiber, other fiber or wire materials that can be coiled and set, and which materials have a low contact angle with the working fluid. For water as working fluid, glass fiber and Cu- and Ni-wire are of special interest, because these materials are compatible with water in a vacuum environment. For fluids in general, wetting and compatibility should be taken into account in the selection of materials.

Required coil sizes are dependent on the application and working fluid properties, some rough indications are: wire diameter: 5 -500 μm μm; tube diameter: 10-1000 μm μm; and length of tube: 10 -1000 mm.

The opening between adjacent coils is typically smaller than the wire diameter, but preferably small enough to generate a local high capillary pressure that can keep the liquid inside upon vibration and shocks. The artery diameter is limited to mm-size or sub-mm size to prevent that mechanical shocks lead to irreversible liquid depletion. If the coil spacing is sufficiently small, the liquid has a low chance to be ejected and if it is ejected the capillary force build up by the tube diameter will let the liquid return to fill completely again. A safe way of operation is if the hydraulic pressure generated by the internal diameter is greater than the pressure developed by gravity over the length of the tube.

The stiffness of the coil can be controlled by the wire or fiber material, the wire or fiber diameter, the artery diameter, the coiling density (turns per meter), and the use of multiple parallel wires or fibers.

The stiffness and shear stress in a typical coil with a single wire has been calculated. The stiffness properties of a 100 μm glass fiber in an 0.2 mm inner-0.4 mm outer diameter coil are fit for a coiled artery of 100 mm length, while the shear stress at 10% elongation of the coil is well below critical values (from Wikipedia data, the compressive strength of Eglass is 1080 MPa, the tensile strength is 3445 MPa).

helical spring stiffness soda lime fiber

| | | | | | | |
|---|---|---|---|---|---|---|
| d_wire | m | 0.000030 | 0.000050 | 0.000080 | 0.000100 | 0.000125 |
| D_int | m | 0.000200 | 0.000200 | 0.000200 | 0.000200 | 0.000200 |
| D_out | m | 0.000260 | 0.000300 | 0.000360 | 0.000400 | 0.000450 |
| D_eff | m | 0.000230 | 0.000250 | 0.000280 | 0.000300 | 0.000325 |
| L coil | m | 0.1 | 0.1 | 0.1 | 0.1 | 0.1 |
| spacing | m | 0.000010 | 0.000010 | 0.000010 | 0.000010 | 0.000010 |
| pitch | m | 0.00004 | 0.00006 | 0.00009 | 0.00011 | 0.000135 |
| n turns | | 2500 | 1667 | 1111 | 909 | 741 |
| E | N/m2 | 7.00E+10 | 7.20E+10 | 7.00E+10 | 7.20E+10 | 7.20E+10 |
| Poissons | | 0.24 | 0.22 | 0.24 | 0.22 | 0.22 |
| G | N/m2 | 2.82E+10 | 2.95E+10 | 2.82E+10 | 2.95E+10 | 2.95E+10 |
| stiffness | N/m (g/cm) | 0.09 | 0.9 | 6 | 15 | 35 |
| longation (abs) | m | 0.01 | 0.01 | 0.01 | 0.01 | 0.01 |
| elongation (rel) | | 0.1 | 0.1 | 0.1 | 0.1 | 0.1 |
| Force | N | 0.0009 | 0.01 | 0.06 | 0.2 | 0.4 |
| shear stress | N/m2 | 2.0E+07 | 4.5E+07 | 8.3E+07 | 1.1E+08 | 1.5E+08 |

A capillary tube with given internal diameter will enable transport of water. The water flow can be estimated easily for any the capillary pressure difference over the tube. With conservative values for the dimensions, properties and capillary pressures about 4 tubes of outer diameter of 0.4 mm are sufficient for the required water flow to cool a candle or bulb. The transport is very sensitive to the internal tube diameter.

flow in capillary tube

| | | | |
|---|---|---|---|
| p0 | Pa | 1000 | 1000 |
| p1 | Pa | 0 | 0 |
| L | m | 0.1 | 0.1 |
| diam_int | m | 0.0002 | 0.00025 |
| liquid viscosity at 20 deg C. | Pa · s | 1.00E−03 | 1.00E−03 |
| flow | m3/s | 3.93E−10 | 9.59E−10 |
| liquid density | kg/m3 | 1000 | 1000 |
| flow | kg/s | 3.93E−07 | 9.59E−07 |
| evap enthalpy | kJ/ml | 2.4 | 2.4 |
| potential heat transfer per tube | W | 0.94 | 2.30 |
| # tubes | | 4 | 4 |
| potential total transfer | W | 3.8 | 9.2 |

Relevant elements of the invention are a coiled wire or fiber that forms an artery wick, multiple turns with a small spacing between the turns, glass (or plastic or ceramic) fiber or metal wire as the material that is coiled, and one, double or triple helix coiled fibers or wires.

Metal wire coiling is a known technology. Especially for GLS incandescent bulbs, tungsten wire coiling is a technology that is or was widely applied. Coiling multiple wires in one coil (double helix coil) is very effective to increase the longitudinal stiffness, coiling two parallel wires in one coil will increase the stiffness by a factor of 4. Glass fiber coiling may be done as follows: the continuous (coated or uncoated) glass fiber is lead through an feed through oven (e.g. a heated pipe) which heats the fiber to a temperature that enables easy plastic bending. The fiber is coiled on a very long but not infinitely long rotating mandrill that is axially forwarded while rotating, which can be a carbon wire, which is also preheated by a feed-through oven. The coiled glass is set in its permanent shape by gradual cooling and is taken from the mandrill in cold state and cut into the required length.

Several options for connections can be used (see also drawings):

In a first option, a central part of the artery coil can be wrapped one or few times around the cylindrical evaporator of the bulb or candle, with the two outer ends hanging freely in the vapor chamber. Fixation on the evaporator cylinder can be done with an appropriate glue, e.g. a sol-gel. This wick structure can be combined with a sol-gel wick coating on the cylindrical evaporator;

In a second option, similar to 1, the central part of the coil is wrapped around the cylindrical evaporator, and the outer coil ends are fixated at the outer top of the bulb or candle with an appropriate glue;

In a third option, similar to 1, the central part of the coil is wrapped around the cylindrical evaporator, and the two strings are mounted to the glass wall of the vapor chamber to get a sufficiently dense coverage of the glass, preferably in a systematic way. For instance the coils can run in a double helix from bulb/candle top to the base, also two coiled fibers or wires can be combined in a quadruple helix.

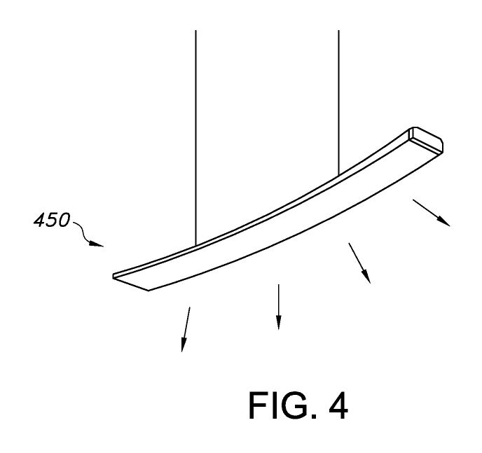

FIG. 4 schematically shows a luminaire 450. The luminaire 450 comprises one or more lamps according to the previously discussed embodiments of the lamps.

A number of further test were performed with different coils with a wire diameter of 100 μm and an external diameter of 400 μm, including different distances d4 between adjacent elements of the helix. The distances d4 (internal spacing) were in the range of 0 μm-40 μm. Very good water transport functionality was measured with coils that had no spacing between the adjacent wires, results were comparable to simple capillary tubes. With increasing spacing between the turns the water transport properties decreased slightly, but up to about 40 μm very good water transport functionality was perceived (70% of the water transport at a 0 μm spacing, which is still very good.

1. A lamp comprising a light source, configured to generate light source light, and a light transmissive heat pipe configured to dissipate thermal energy from the light source, wherein at least part of the heat pipe is transmissive for at least part of the light source light and wherein the light source is configured to provide at least part of the light source light downstream from the heat pipe, wherein the heat pipe has an internal surface and includes a heat pipe working fluid, wherein the heat pipe further includes a flexible conduit configured as wick, wherein the flexible conduit comprises a flexible conduit connection part, an outer face, a longitudinal channel with an opening at an end, and at least one side opening in the outer face to the longitudinal channel, wherein the flexible conduit is connected at the flexible conduit connection part with the internal surface at a first position, and wherein the light source is configured external from the light transmissive heat pipe.

2. The lamp according to claim 1, wherein the longitudinal channel has an equivalent circular diameter selected from the range of 10-1000 μm.

3. The lamp according to claim 1, wherein the flexible conduit has a length which is large enough to be in physical contact with a part of the internal surface most remote from the first position.

4. The lamp according to claim 1, wherein the flexible conduit is provided by a helical structure and wherein the side opening is a helically shaped side opening provided by said helical structure, wherein the helical structure has a diameter selected from the range of 5-500 μm.

5. The lamp according to claim 1, wherein the side opening has a smallest dimension selected from the range of 0.1-500 μm.

6. The lamp according to claim 1, wherein the flexible conduit comprises a plurality of side openings.

7. The lamp according to claim 1, wherein the flexible conduit comprises a light transmissive material.

8. The lamp according to claim 1, wherein the flexible conduit is connected at the flexible conduit connection part with the internal surface at the first position via a sol-gel coating.

9. The lamp according to claim 1, comprising:
a solid state light source and a first envelope at least partially enclosing the solid state light source, thereby forming a first cavity hosting said solid state light source, wherein at least part of the first envelope is transmissive for visible light generated by the solid state light source;
a second envelope at least partially enclosing the first envelope, wherein the first envelope and the second envelope provide a second cavity at least partially enclosing the solid state light source, wherein at least part of the second envelope is transmissive for visible light generated by the solid state light source and transmitted through the first envelope into the second cavity, wherein the second cavity is configured as said heat pipe comprising said heat pipe working fluid.

10. The lamp according to claim 9, further comprising a solid state light source support in thermal contact with the first envelope at the first position.

11. The lamp according to claim 9, wherein the solid state light source support includes a heat sink, and wherein the heat sink is in physical contact with the first envelope at the first position.

12. The lamp according to claim 9, wherein one or more of the first envelope and the second envelope comprise a material independently selected from the group consisting of glass, a translucent ceramic, and a light transmissive polymer, and wherein the second envelope has the shape of a bulb lamp, a candle lamp, or a tubular lamp.

13. The lamp according to claim 9, wherein the heat pipe working fluid comprises one or more of H₂O, methanol, ethanol, 1-propanol, isopropanol, butanol, acetone, and ammonia.

14. A light transmissive heat pipe configured to dissipate thermal energy from a light source, wherein at least part of the heat pipe is transmissive for visible light, wherein the heat pipe has an internal surface and includes a heat pipe working fluid, wherein the heat pipe further includes a flexible conduit configured as wick, wherein the flexible conduit comprises a flexible conduit connection part, an outer face, a longitudinal channel with an opening at an end, and at least one side opening in the outer face to the longitudinal channel, wherein the flexible conduit is connected at the flexible conduit connection part with the internal surface at a first position.

15. The light transmissive heat pipe according to claim 14, wherein the longitudinal channel has an equivalent circular diameter selected from the range of 10-1000 μm, wherein the flexible conduit is provided by a helical structure and wherein the side opening is a helically shaped side opening provided by said helical structure wherein the helical structure has a diameter selected from the range of 5-500 μm, and wherein the side opening has a smallest dimension selected from the range of 0.1-500 μm.

16. A luminaire comprising at least one lamp according claim 1.
